(19) United States
(12) Patent Application Publication
(10) Pub. No.: US 2002/0165967 A1
(43) Pub. Date: Nov. 7, 2002

(54) Global personalization engine

(76) Inventor: Paul A. Morgan, Aptos, CA (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/846,321

(22) Filed: May 2, 2001

(51) Int. Cl. G06F 15/16

(52) U.S. Cl. 709/227; 709/230

(57) ABSTRACT

A system for providing user information to a server computer, including a personalization engine within a server computer, including an ID generator generating a user ID, in response to a user initiating a session accessing the server computer, a banner processor embedding a banner link within a web page to be transmitted from the server computer to the user, the banner link linking to a central computer and including the user ID, and a request generator issuing a request to the central computer to provide user information corresponding to the user ID, a database of user information indexed by user subscriber numbers, a match processor within the central computer receiving the user ID and a user subscriber number, and associating the user ID with the user subscriber number, and a database manager retrieving user information from the database for transmission to the server computer, in response to the request generator. A method is also described and claimed.

### FIELD OF THE INVENTION

The present invention relates to providing a central repository of personal user information accessible to web server computers.

### BACKGROUND OF THE INVENTION

Today the web is full of personalized content-premium web sites whether they be e-commerce or information portals go to great lengths to customize their content to better serve or inform the user. The current state of the art in this field is limited to each and every site maintaining a database of users/visitors and their browsing habits or interests and identifying a user through either a login process or by an http based user identification scheme. The disadvantage of this approach is that the user creates islands of personal information all over the web without any easy way to ensure what information is being kept or how up-to-date it is. In addition, web site developers must reinvent user identification and storage logic on each site they build.

### SUMMARY OF THE INVENTION

The present invention provides a method and system for providing centrally archived user information to web servers.

The present invention preferably includes a centralized Internet personalization service that can be tapped for information by a web site on behalf of a visitor entering the site. Such a service is referred to herein as the “AboutMe.com” service. The benefit of such a system is that web site vendors can consult a centralized database to extract information about a user/visitor to create a better experience for him. For example, a visitor to the Gap store's web site would automatically be sent to the appropriate store—men to the men's section, and women to the women's section. Such information could also be used to better target special offers, news, announcements and general advertising.

Preferably, the present invention enables a user to ensure that his information is provided in an anonymous way.

The present invention is not limited to generating better personalized content, but also offers a web site proprietor the ability to contact a visitor via the AboutMe.com service after the visitor has left the on-line web site. Preferably, controls are provided for a visitor to protect his anonymity. Incentives can be offered to attract users and web site vendors to use the system of the present invention.

The system described herein offers a user identification mechanism that can be built into today's application server.

The first approach that comes to mind when trying to pass an identity in web applications is use of the HTTP cookie. A cookie may be given attributes and an expiry date that cause a client's browser to store the cookie on a hard disk and reload it each time the browser is started. For example, this is how Amazon.com achieves one-click shopping and auto-login. Such a cookie is referred to as persistent. The problem with this approach is that, for security reasons, a cookie will only be passed back to the issuing domain. Thus a persistent cookie alone is not sufficient to pass a user's identity to every site he visits. Instead, in a preferred embodiment of the present invention, a user's browser, an AboutMe.com server and an AboutMe friendly site perform an exchange, the end result of which is that the AboutMe friendly site becomes aware of the user's identity as described hereinbelow.

There is thus provided in accordance with a preferred embodiment of the present invention a system for providing user information to a server computer, including a personalization engine within a server computer, including an ID generator generating a user ID, in response to a user initiating a session accessing the server computer, a banner processor embedding a banner link within a web page to be transmitted from the server computer to the user, the banner link linking to a central computer and including the user ID, and a request generator issuing a request to the central computer to provide user information corresponding to the user ID, a database of user information indexed by user subscriber numbers, a match processor within the central computer receiving the user ID and a user subscriber number, and associating the user ID with the user subscriber number, and a database manager retrieving user information from the database for transmission to the server computer, in response to the request generator.

There is further provided in accordance with a preferred embodiment of the present invention a method for providing user information to a server computer, including generating a user ID, in response to a user initiating a session accessing a server computer, embedding a banner link within a web page to be transmitted from the server computer to the user, the banner link linking to a central computer and including the user ID, issuing a request to the central computer to provide user information corresponding to the user ID, receiving the user ID and a user subscriber number, associating the user ID with the user subscriber number, retrieving user information from a database of user information indexed by user subscriber numbers, based on the user subscriber number associated with the user ID, and transmitting the user information from the central computer to the server computer, in response to the request.

There is yet further provided in accordance with a preferred embodiment of the present invention a system for providing user information to a server computer, including an ID generator generating a user ID, in response to a user initiating a session accessing a server computer, a banner processor embedding a banner link within a web page to be transmitted from the server computer to the user, the banner link linking to a central computer and including the user ID, and a request generator issuing a request to the central computer to provide user information corresponding to the user ID.

There is additionally provided in accordance with a preferred embodiment of the present invention a method for providing user information to a server computer, including generating a user ID, in response to a user initiating a session accessing a server computer, embedding a banner link within a web page to be transmitted from the server computer to the user, the banner link linking to a central computer and including the user ID, and issuing a request to the central computer to provide user information corresponding to the user ID.

There is moreover provided in accordance with a preferred embodiment of the present invention a system for providing user information to a server computer, including a database of user information indexed by user subscriber numbers, a match processor within a central computer receiving a user ID and a user subscriber number from a server computer, and associating the user ID with the user subscriber number, and a database manager retrieving user information about a user from said database in response to a request including the user ID.

There is further provided in accordance with a preferred embodiment of the present invention a method for providing user information to a server computer, including receiving a user ID and a user subscriber number from a server computer, associating the user ID with the user subscriber number, and transmitting user information about a user from a database of user information indexed by user subscriber numbers, in response to a request including the user ID.

### BRIEF DESCRIPTION OF THE DRAWINGS

The present invention will be more fully understood and appreciated from the following detailed description, taken in conjunction with the drawings in which:

FIG. 1A is an illustration of a login screen through which a user logs into a central computer, in accordance with a preferred embodiment of the present invention;

FIG. 1B is an illustration of a registration screen through which a user registers himself with a central computer, in accordance with a preferred embodiment of the present invention;

FIG. 2A is an illustration of a screen through which a registered user describes his personal profile to a central computer, in accordance with a preferred embodiment of the present invention;

FIG. 2B is an illustration of a screen through which a registered user selects a mode to be contacted, in accordance with a preferred embodiment of the present invention;

FIG. 3A is an illustration of a welcome screen, presented by a central computer and personalized to a specific registered user, in accordance with a preferred embodiment of the present invention;

FIG. 3B is an illustration of a message inbox, managed by a central computer and personalized to a specific registered user, in accordance with a preferred embodiment of the present invention;

FIG. 3C is an illustration of a third party home page, personalized to a specific registered user and including an indication that the page has been personalized through use of a personalization system in accordance with a preferred embodiment of the present invention;

FIG. 3D is an illustration of a third party generic home page including an indication that the page is not personalized to a specific user, in accordance with a preferred embodiment of the present invention;

FIG. 3E is an illustration of a third party web page generated as a follow up to a message directed to a user, in accordance with a preferred embodiment of the present invention;

FIG. 4A is an illustration of a short message service (SMS) message on a personal data assistant (PDA), personalized to a specific registered user, in accordance with a preferred embodiment of the present invention;

FIG. 4B is an illustration of a web page on a PDA, personalized to a specific registered user in accordance with a preferred embodiment of the present invention;

FIG. 5A is an illustration of a use case wherein a registered user goes to a web page generated as a follow up to a message directed to the user, in accordance with a preferred embodiment of the present invention;

FIG. 5B is an illustration of a use case wherein an unregistered user goes to a web page, registers with a central computer, and is subsequently presented with a personalized web page, in accordance with a preferred embodiment of the present invention;

FIG. 5C is an illustration of a use case wherein a registered but unrecognized user goes to a web page, logs in with a central computer and is subsequently presented with a personalized web page, in accordance with a preferred embodiment of the present invention;

FIG. 5D is an illustration of a use case wherein a registered user checks messages and edits his profile on a central computer, in accordance with a preferred embodiment of the present invention;

FIG. 5E is an illustration of a use case wherein a notification is sent to a user a personal data assistant (PDA), in accordance with a preferred embodiment of the present invention;

FIG. 6 is a simplified block diagram of a global personalization system in accordance with a preferred embodiment of the present invention; and

FIG. 7 is a simplified flowchart of a method for global personalization in accordance with a preferred embodiment of the present invention.

### DETAILED DESCRIPTION OF A PREFERRED EMBODIMENT

The present invention provides a method and system for providing centrally archived user information to web servers.

The present invention includes a global personalization system that enables third party web sites to identify profiles of users who visit their sites. A user who registers with the personalization system of the present invention can subsequently be identified by third parties who use the personalization system. The present invention obviates the need for third parties to individually collect their own personal profile data about each user who visits their sites. Instead, the personalization system of the present invention provides a service through which third parties can determine a personal profile through access to a central archive of user profiles.

In turn, third parties can use user profile data received from the central archive to dynamically personalize their web pages and target them to specific users. The present invention also enables third parties to contact specific users who visit their sites after such users have left their sites, using a mode of contact selected by the users themselves.

Each user's personal profile data included in the central archive is preferably entered by the user himself. Thus it may be appreciated that the present invention provides many advantages to users who register themselves, including:

each such user has a unique personal profile circulating about the web, rather than separate profiles for each web site that has collected his data;

each such user can easily control his own profile data;

each such user can modify a single profile and have such modifications circulated globally;

each such user can remove his information from a single source and thereby remove it globally

each such user has control over his privacy and can control which third parties are able to access his personal information; and

each such user can choose to be anonymous by providing non-personal information only—a user can remain anonymous yet still enter preference information and gain an account on the personalization system.

The present invention also provides many advantages to third party web sites who use the personalization system, including:

each such third party does not have to create its own web interface to collect its own user profile data;

each such third party can be sure that its user profile data is current and includes changes and updates received from users;

each such third party has the ability to directly contact users who have visited their sites, after the users leave their site, subject to the users' contact preferences.

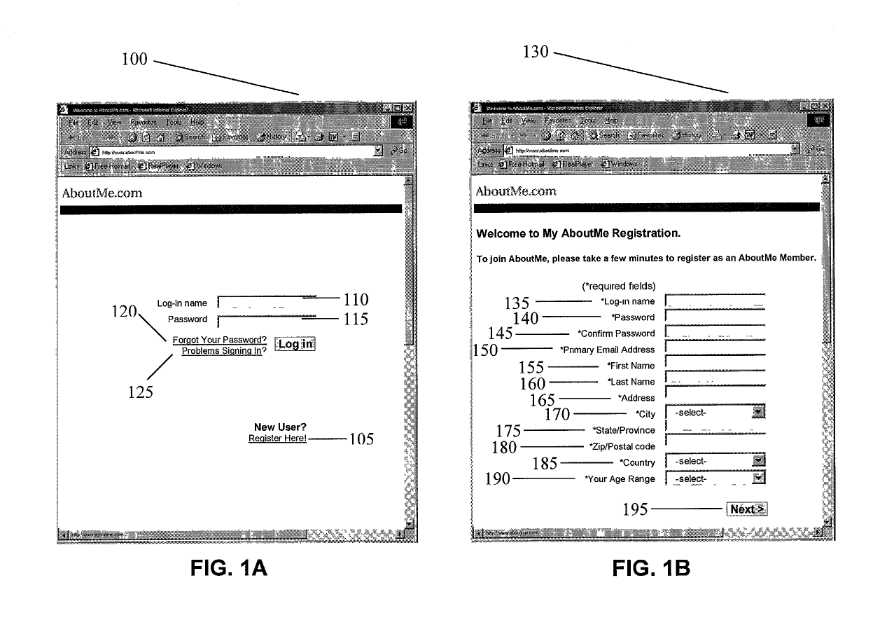

Reference is now made to FIG. 1A, which is an illustration of a login screen through which a user logs into a central computer, in accordance with a preferred embodiment of the present invention. A new user who wishes to subscribe to the personalization service of the present invention is presented a web page 100, and clicks on a “Register Here!” hyperlink 105. An existing user who wishes to access his personal profile preferably logs in by entering a login name 110 and a password 115. If the existing users forgets his password, he can click on a “Forgot Your Password?” link 120 to remedy this. If he has difficulty logging in, he can click on a “Problems Signing In?” link 125.

Reference is now made to FIG. 1B, which is an illustration of a registration screen through which a new user registers himself with a central computer, in accordance with a preferred embodiment of the present invention. In order to subscribe to the personalization service of the present invention, a new user is presented a web page 130. The user preferably enters a desired login name 135 and password 140. The user enters a password confirmation 145, in order to double-check his spelling of password 140.

The user enters a primary e-mail address 150, a first name 155 and last name 160, and an address 165. The user selects a city 170 from a list of cities displayed via a pull-down menu, a state or province 175, a zip code or postal code 180 and a country 185 from a list of countries displayed via a pull-down menu. Finally, the user enters an age range 190 from a list of ranges displayed via a pull-down menu. Fields marked with an asterisk are required entries. After completing web page 130, the user clicks on a “Next>” button 195 to proceed further.

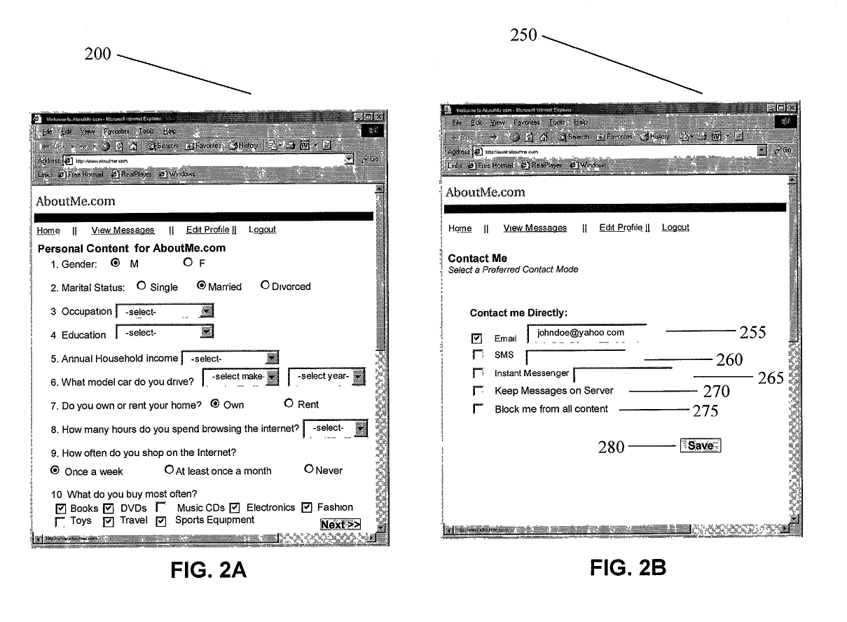

Reference is now made to FIG. 2A, which is an illustration of a screen through which a registered used describes his personal profile to a central computer, in accordance with a preferred embodiment of the present invention. After a user has filled in information on web page 130 (FIG. 1B), he is presented with a web page 200 and preferably proceeds to describe a personal profile. For example, FIG. 2A includes inter alia selections 205, 210, 215 and 220 for occupation, education, income and car.

For example, FIG. 2A illustrates selections 205, 210, 215, 220, 225, 230, 235 and 240 for Apparel, Autos, Books, Computers & Technology, Entertainment, Personal Finance, Sports and Travel, respectively. Shown in FIG. 2A are selections 205 of Harrods and Nordstrom's for Apparel, a selection 210 of BMW for Autos, a selection 220 of Buy.com for Computers & Technology, a selection 230 of Charles Schwab for Personal Finance, selections 235 of SportsMart.com and SportingGoods.com for Sports, and selections 240 of Leisure Planet, Travelocity and World Travel for Travel. After making appropriate selections, the user clicks on a “Next>” button 245 to proceed further.

Reference is now made to FIG. 2B, which is an illustration of a screen through which a registered used selects a mode to be contacted, in accordance with a preferred embodiment of the present invention. After a user has filled in selections on web page 200 (FIG. 2A), he is presented with a web page 250 and preferably proceeds to select a mode of contact. Illustrated in FIG. 2B are five modes, including:

1. Contact via a specified e-mail address 255.

2. Contact via a short message service (SMS) 260, used with mobile devices such as personal digital assistants (PDAs).

3. Contact via an instant messenger service 265, such as that of America On-Line (AOL).

4. A request 270 not to be contacted automatically (push mode), but rather to retain messages on a server until the user himself extracts his messages (pull mode).

5. A request 275 to block all content designated for the user.

In a preferred embodiment of the present invention, a user may select a method of contact for each individual category. For example, a rules engine, similar to e-mail rules, could send sports related information to a specified e-mail address, as per mode 255, computer information could be archived on the server, as per mode 270, and all other information could be blocked, as per mode 275.

Preferably the present invention enables third party web sites that use the personalization system of the present invention to communicate with a user via the central computer after the user has visited their site, even if the user has left their site. The mode of contact selected by the user in web page 250 controls the medium of communication between such third party web sites and the user.

Upon selecting one or more modes of contact, the user clicks on a “Save” button 280 to save his personal portfolio on the central computer.

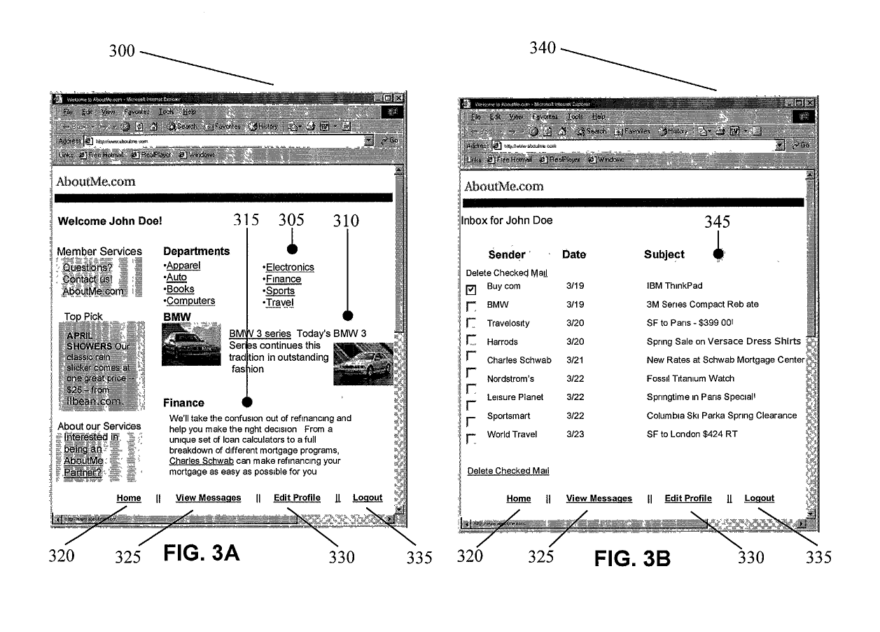

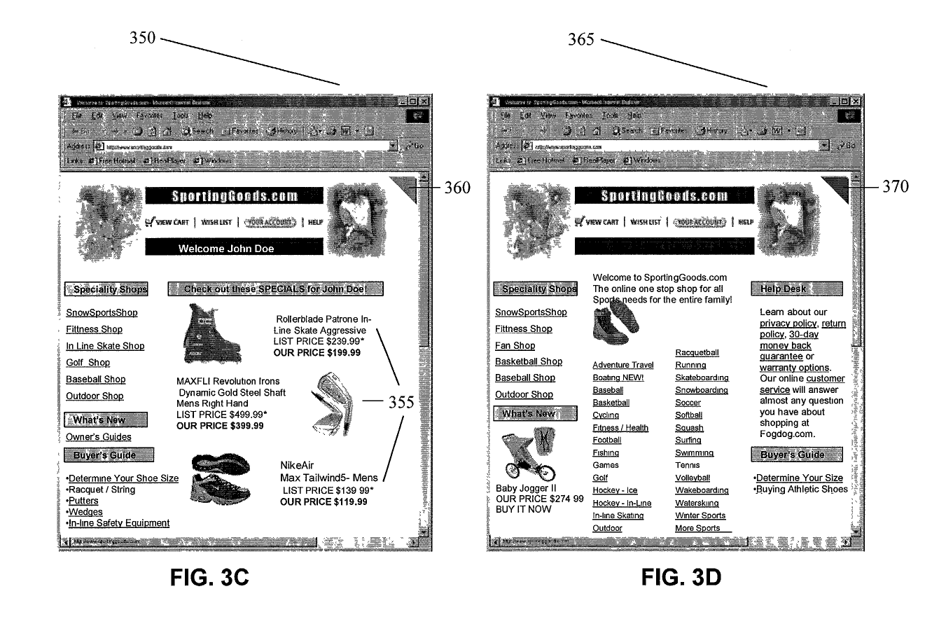

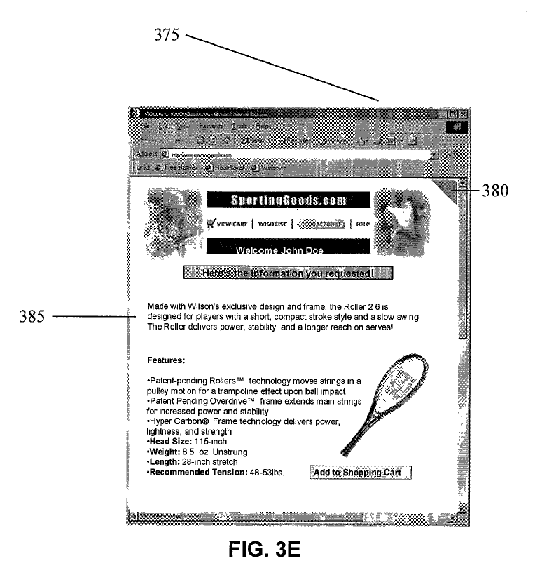

Reference is now made to FIG. 3A, which is an illustration of a welcome screen, presented by a central computer and personalized to a specific registered user, in accordance with a preferred embodiment of the present invention. A web page 300 has preferably been personalized for a registered user, in accordance with his personal profile. Web page 300 includes a list of departments 305 corresponding to the departments listed on web page 200 (FIG. 2A). A section 310 for autos includes a BMW in accordance with the selection 210 (FIG. 2A) made by the user on web page 200, and a section 315 for finance includes material from Charles Schwab in accordance with the selection 230 (FIG. 2A) made by the user on web page 200.

The user can navigate to a home page by clicking on a “Home” link 320, to his message inbox by clicking on a “View Messages” link 325, or to a page for editing his personal profile by clicking on an “Edit Profile” link 330. He can logout by clicking on a “Logout” link 335.

It is noted that web page 300 appears like a typical portal home page. In a preferred embodiment of the present invention, the web site on the central computer appears like other portal sites, such as myYahoo and myExcite.

Reference is now made to FIG. 3B, which is an illustration of a message inbox, managed by a central computer and personalized to a specific registered user, in accordance with a preferred embodiment of the present invention. When a user clicks on the “View Messages” link 325, he is presented a web page 340 with a list of personal messages. As shown in FIG. 3B, the messages preferably originate from vendors corresponding to the selections 205-240 that the user indicated on web page 200 (FIG. 2A). For example, Harrods and Nordstrom's are the selections 205 made for Apparel, and BMW is the selection 210 made for Autos.

The user can navigate to other pages or logout using the same links 320-335 indicated in FIG. 3A.

Reference is now made to FIG. 3C, which is an illustration of a third party home page, personalized to a specific registered user and including an indication that the page has been personalized through use of a personalization system in accordance with a preferred embodiment of the present invention. A third party web site preferably uses the personalization system of the present invention in order to identify a user's profile and thereby customize its web pages for the user. Shown in FIG. 3C is a customized web page 350 including content 355 personalized for a specific user. Web page 350 belongs to a SportingGoods.com web site, which is one of the selections 235 that the user indicated on web page 200 (FIG. 2B).

Web page 350 includes a green triangle 360 in its upper right hand comer. The color green in FIG. 3C indicates that web page 350 has been enabled for customization using the personalization system of the present invention.

Reference is now made to FIG. 3D, which is an illustration of a third party generic home page including an indication that the page is not personalized to a specific user, in accordance with a preferred embodiment of the present invention. Shown in FIG. 3D is a web page 365 including a red triangle 370 in its upper right hand comer. The color red indicates that web page 365 has not been enabled for customization using the personalization system of the present invention. In order to receive a customized page, an existing user can log in to a central personalization system by clicking on the red triangle banner, and a new user can register with the central personalization system by clicking on the red triangle banner.

Reference is now made to FIG. 3E, which is an illustration of a third party web page generated as a follow up to a message directed to a user and saved on a central computer, in accordance with a preferred embodiment of the present invention. Shown in FIG. 3E is a web page 375 including a green triangle 380 in its upper right hand comer, indicating that web page 375 has been enabled for customization using the personalization system of the present invention. Web page 375 includes personal content 385 intended for the specific user, and is preferably accessed by the user following a link included within a message that a web site owner sent to the visitor. FIG. 3E indicates that the user had expressed interest in tennis rackets in his personal profile, and thus web page 375 includes content 385 about a tennis racket.

Preferably, the green and red triangles indicated in FIGS. 3C-3E include hyperlinks to a website for interacting with the personalization system of the present invention.

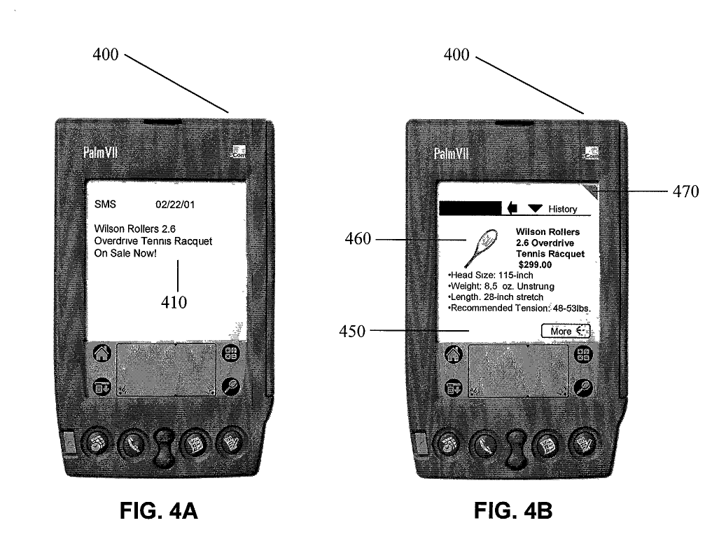

Reference is now made to FIG. 4A, which is an illustration of a short message service (SMS) message on a personal data assistant (PDA), personalized to a specific registered user, in accordance with a preferred embodiment of the present invention. Shown in FIG. 4A is a PDA 400 including a message 410 intended for a specific user. Message 410 regards a Wilson tennis racket, and is transmitted in response to the user having expressed interest in such a racket. Preferably PDA 400 is a wireless device, such as a Palm VII PDA, and message 410 is transmitted over a wireless network.

Reference is now made to FIG. 4B, which is an illustration of a web page on a PDA, personalized to a specific registered user, in accordance with a preferred embodiment of the present invention. Shown in FIG. 4B is a web page 450 containing personal content 460, similar to the personalized content 385 in web page 375 (FIG. 3E). Web page 450 also includes a green triangle 470, indicating that web page 450 has been enabled for customization using the personalization system of the present invention.

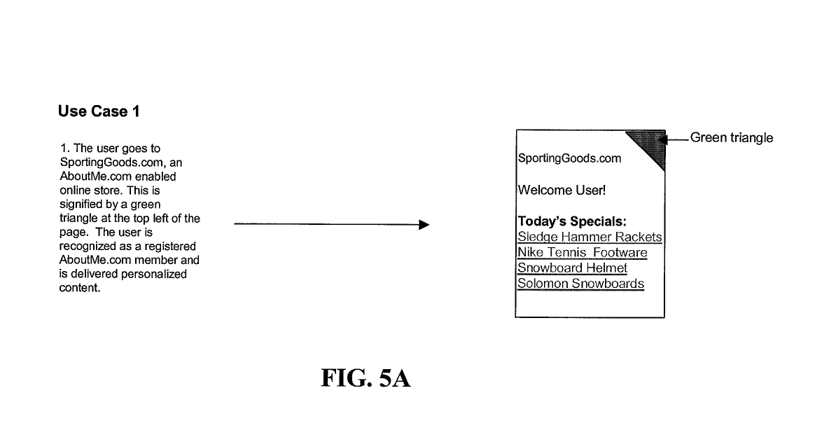

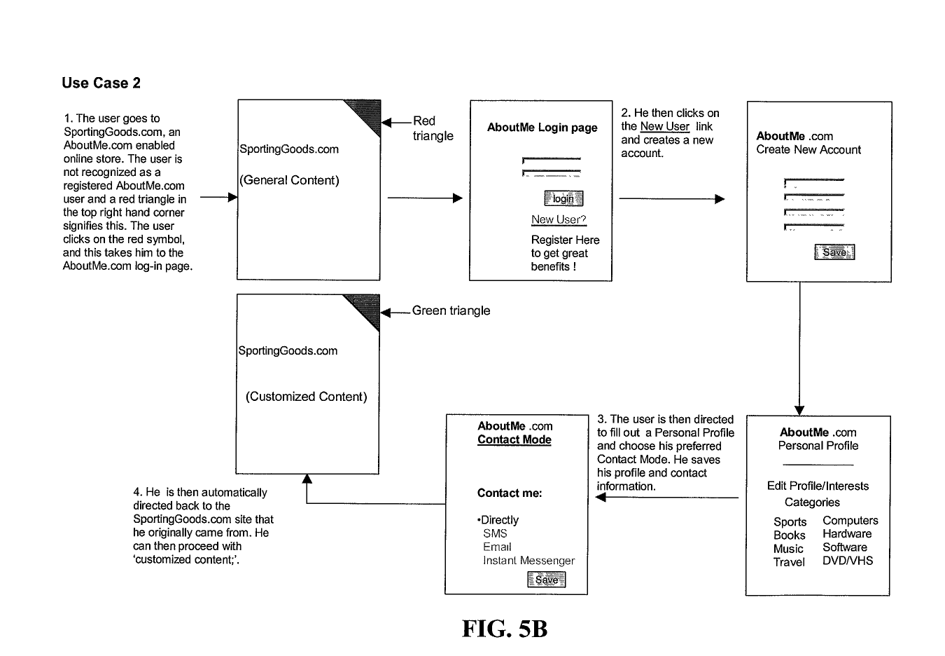

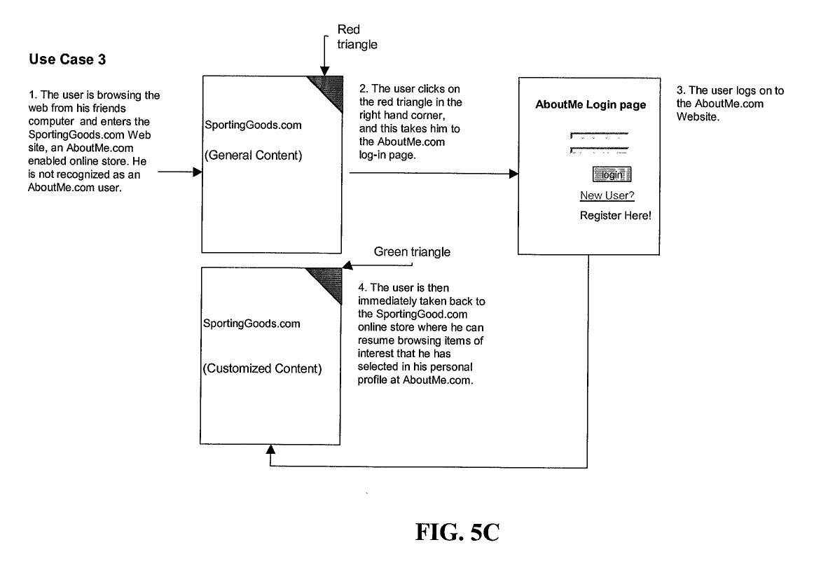

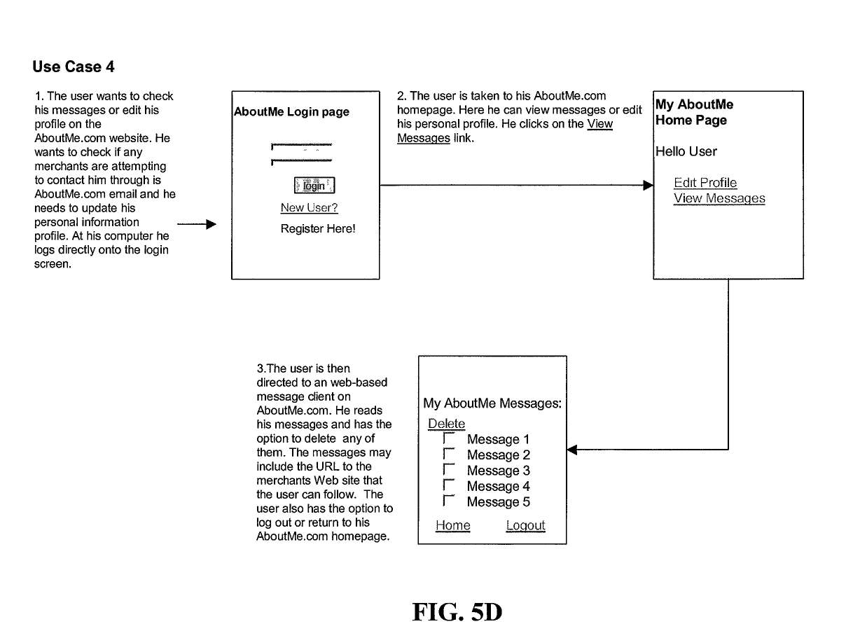

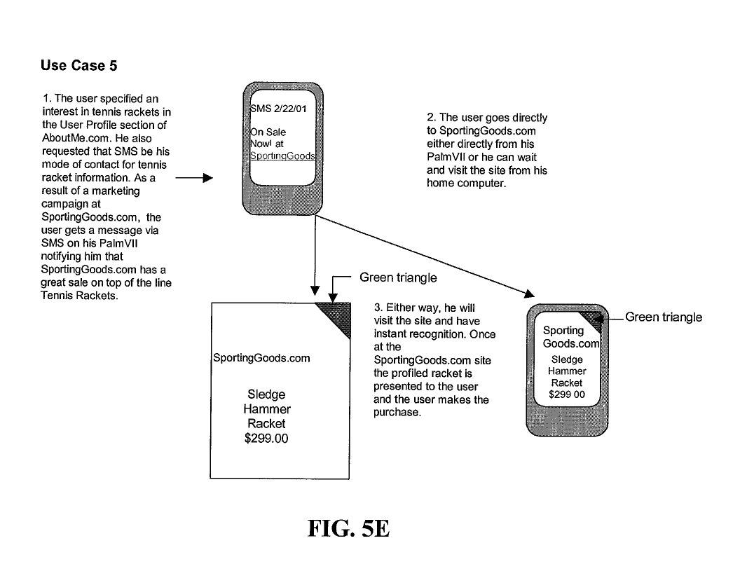

Reference is now made to FIG. 5A, which is an illustration of a use case wherein a registered user goes to a web page generated as a follow up to a message directed to the user, in accordance with a preferred embodiment of the present invention. As indicated in FIG. 5A, a user goes to a third party web page, SportingGoods.com, such as web page 350 illustrated in FIG. 3C. Preferably, SportingGoods.com is enabled to use the personalization system of the present invention. Preferably, the user accesses the web page through a link included with a message sent to the user by SportingGoods.com. The user is recognized, and the web page includes personalized content, such as content 355 (FIG. 3C). The web page includes a green triangle in its upper right hand comer, such as green triangle 360 (FIG. 3C), indicating that the page has been customized for the user.

Reference is now made to FIG. 5B, which is an illustration of a use case wherein an unregistered user goes to a web page, registers with a central computer, and is subsequently presented with a personalized web page, in accordance with a preferred embodiment of the present invention. As indicated in FIG. 5B, a user goes to a third party web page, SportingGoods.com, such as web page 365 illustrated in FIG. 3D. Preferably, SportingGoods.com is enabled to use the personalization system of the present invention. The user is not recognized, and the web page does not include personalized content. The web page includes a red triangle in its upper right hand comer, such as red triangle 370 (FIG. 3D), indicating that the page has not been customized for the user.

Preferably, the user clicks on the red triangle, which links him to a login page, such as web page 100 (FIG. 1A). The user clicks on a “New User” link and is presented with a registration page, such as web page 130 (FIG. 1B), to create a new account and set up a personal profile with the personalization system of the present invention. After setting up his account and profile, the user is then automatically directed back to the SportingGoods.com site where he originated, and is presented with personalized content, such as content 355 (FIG. 3C). The SportingGoods.com web page now includes a green triangle in its upper right hand comer, indicating that the page has been customized for the user.

Reference is now made to FIG. 5C, which is an illustration of a use case wherein a registered but unrecognized user goes to a web page, logs in with a central computer and is subsequently presented with a personalized web page, in accordance with a preferred embodiment of the present invention. Although a user has registered with the personalization system of the present invention, he nevertheless may not be recognized in certain instances. For example, the user may by browsing the web from a computer that is not his; or a user may be browsing the web from his computer, but has deleted his cookies.

As indicated in FIG. 5C, a user goes to a third party web page, SportingGoods.com, such as web page 365 illustrated in FIG. 3D. Preferably, SportingGoods.com is enabled to use the personalization system of the present invention. The user is not recognized, and the web page does not include personalized content. The web page includes a red triangle in its upper right hand comer, such as red triangle 370 (FIG. 3D), indicating that the page has not been customized for the user.

Preferably, the user clicks on the red triangle, which links him to a login page, such as web page 100 (FIG. 1A). The user clicks on a “Login” button to identify himself by a login name and password. After logging in and identifying himself, the user is then immediately directed back to the SportingGoods.com site to resume browsing, and is presented with personalized content, such as content 355 (FIG. 3C). The SportingGoods.com web page now includes a green triangle in its upper right hand comer, indicating that the page has been customized for the user.

Reference is now made to FIG. 5D, which is an illustration of a use case wherein a registered user checks messages and edits his profile on a central computer, in accordance with a preferred embodiment of the present invention. Shown in FIG. 5D is a login page, such as web page 100 (FIG. 1A). The user logs in by entering his login name and password and is presented with a personalized home page, such as web page 300 (FIG. 3A). The user clicks on a link “View Messages,” such as link 325 (FIG. 3A), to check is any merchants are attempting to contact him through his account with the personalization system of the present invention. The user is presented with a web page including a list of messages in his inbox, such as web page 340 (FIG. 3B). The messages may include URLs to merchants' web sites that the user can follow. As illustrated in FIG. 5D, the user can delete any of his messages.

Alternatively, the user can click on a link “Edit Profile” and edit his personal profile.

Reference is now made to FIG. 5E, which is an illustration of a use case wherein a notification is sent to a user via a personal data assistant (PDA), in accordance with a preferred embodiment of the present invention. The user has specified SMS as his mode of contact 260 in web page 250 (FIG. 2B). As shown in FIG. 5E, a user having a PDA, such as PDA 400 (FIG. 4A), receives a message on his PDA regarding a sale on tennis rackets, in response to his having expressed an interest in tennis rackets. The user can either link to the SportingGoods.com site directly from his PDA, or else visit the site from his home computer. In either case, when the user goes to the SportingGoods.com site, he will be presented with a customized web page such as web page 450 including personal content 460 (FIG. 4B) on his PDA, or such as web page 375 including personal content 385 (FIG. 3E) on his home computer.

It should be apparent to those skilled in the art that FIGS. 1-5 merely illustrate an example storyboard and use cases, which correspond to but one of many ways to implement the present invention.

Implementation Details

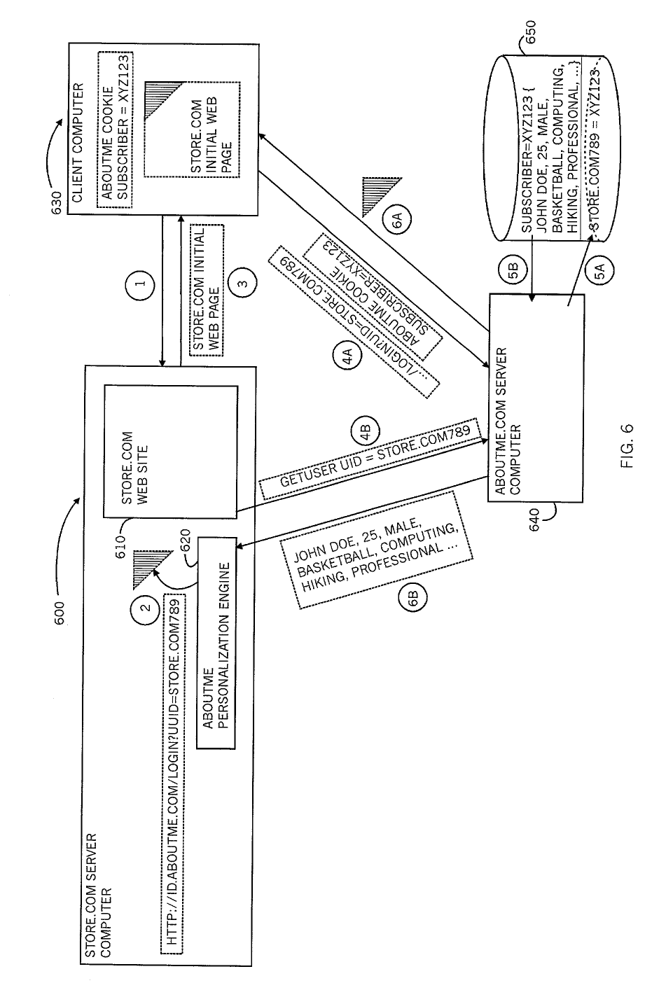

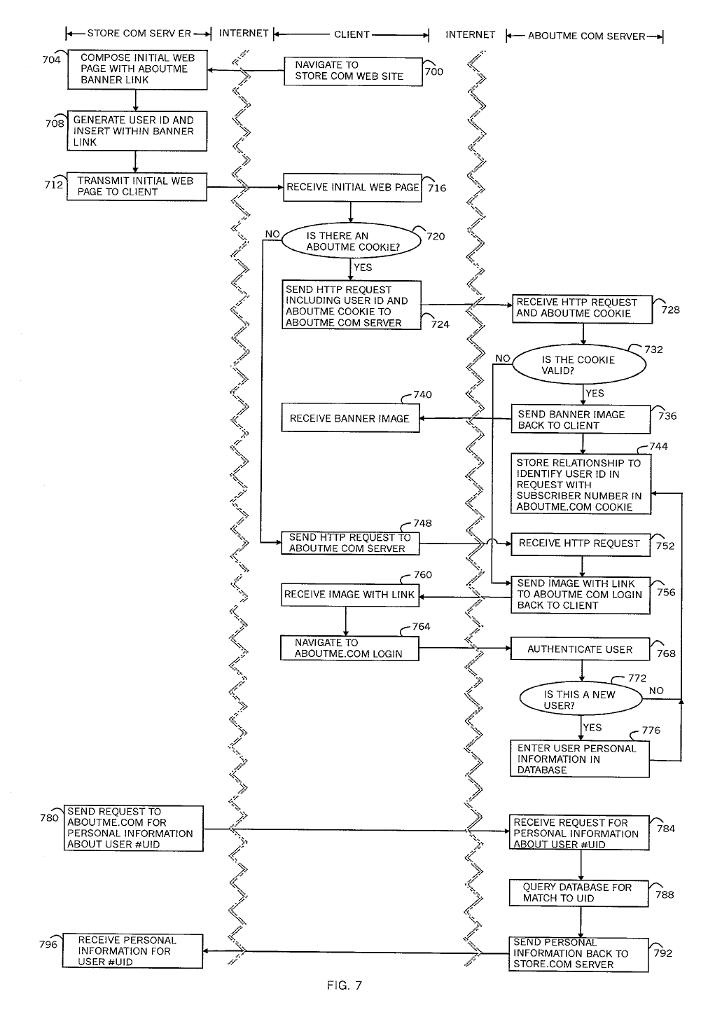

Reference is now made to FIG. 6, which is a simplified block diagram of a global personalization system in accordance with a preferred embodiment of the present invention. System components are illustrated in FIG. 6 as numbered solid blocks, and data that flows through the components are illustrated as unnumbered dashed blocks. Shown in FIG. 6 is a server computer 600, belonging to an e-commerce vendor, including a web site 610 named store.com. In a preferred embodiment of the present invention, server computer 600 also contains a personalization engine 620. The store.com web site 610 is accessed by a user from a client computer 630.

As described hereinbelow, after client computer 630 accesses store.com web site 610, server computer 630 can, in a preferred embodiment of the present invention, determine personal information about the user through a central computer 640. Central computer 640 has access to a database 650 of personal user information. For purposes of clarity and ease of description, the central computer is referred to herein as “AboutMe.com.”

Database 650 is preferably arranged according to subscriber numbers. For example, as illustrated in FIG. 6, personal information for a user with subscriber number xyz123 includes (i) his name, John Doe; (ii) his interests, basketball, computing and hiking; and (iii) his job classification, professional. Such information is useful to vendors like store.com, in order to customize a web presentation to a specific user, and thus be better able to market their goods and services, and serve the user's needs.

Operation of a preferred embodiment of the present invention is illustrated in FIG. 6 through a series of stages indicated by circled numbers. At stage 1, a user who has previously established an account with AboutMe.com and has a persistent AboutMe cookie makes a request to a web site, such as store.com web site 610 at server computer 600. The AboutMe cookie includes a subscriber number for the user, indicated in FIG. 6 as xyz123.

At stage 2, personalization engine 620 dynamically composes a web page having an AboutMe banner image. The AboutMe banner image is illustrated in FIG. 6 as a shaded triangle, such as green triangle 360 (FIG. 3C), that is inserted into the upper right hand comer of the web page. The URL for the banner image is not a link to a resource at store.com, but rather is preferably a link to a dynamic page generating interface at AboutMe.com. For example, the banner image may link to a Common Gateway Interface (CGI) program. The URL for the banner image is generated by personalization engine 620, and includes a temporary user ID carried as a query string argument in the URL. In a preferred embodiment of the present invention, the user ID is a universally unique identifier (UUID), determined by a UUID generator. As illustrated in FIG. 1, the URL for the banner image is carried as a CGI argument:

http://id.aboutme.com/login?uuid=store.com789,

and the user ID is store.com789.

It may be appreciated that green triangle 360 is but one example of an image for a banner used to transmit a user identity. Many other styles are possible, including invisible banners.

Preferably, the dynamically generated <img> tag for the banner image is also linked to an AboutMe.com login screen. A user can follow this link for direct access to his AboutMe account.

At stage 3, the store.com web page is transmitted to client computer 630. Most of the links in the web page are serviced by store.com, but the banner link goes directly to AboutMe.com. It is noted that accessing of an external site in a portion of a web page is similar to the manner in which DoubleClick (http://www.doubleclick.com) serves web banner advertisements.

At stage 4A, a web browser in client computer 630 accesses the banner link and passes a request to the CGI program at AboutMe.com specified by personalization engine 620, including the user ID argument store.com789. Because the web browser contains a persistent AboutMe cookie, this cookie is also passed from client computer 630 to central computer 640 with the request.

At stage 4B, personalization engine 620 tries to obtain information from central computer 440 about the current user identified by the user ID store.com789. A special request is made from server computer 600 to central computer 640, and the user ID is passed as an argument. As illustrated in FIG. 6, the special request is given by

getUser uid=store.com789

Preferably, the special request is an HTTP request and preferably the special request is a secure request.

At stage 5A, central computer 640, having received both the user ID and the AboutMe.com cookie, is able to match the user ID with the user's subscriber number. As illustrated in FIG. 6, the discovered temporary relationship store.com789=xyz123 is recorded in database 650.

At stage 5B, central computer 640 searches for and retrieves personal information about the user identified by a user ID, in response to the request issued at stage 4B.

At stage 6A, central computer sends back the banner image for the banner link embedded by personalization engine 620, to client computer 630. If the AboutMe cookie is valid, the image returned indicates a recognized user, such a green triangle 360 (FIG. 3C). Otherwise, if the AboutMe cookie is invalid, or if such a cookie was not supplied, an alternative image is sent, such as red triangle 370 (FIG. 3D). The alternative image indicates to the user that he was not recognized, and that he should click on the alternative image to login to AboutMe and establish or re-establish his identity.

At stage 6B, the user's personal information retrieved from database 650 is sent from central computer 640 to server computer 600. Preferably the personal information is sent as an XML document. It may be appreciated that after stage 6B, server computer can identify the user who accessed web site 610 at stage 1, and thereby can tailor and target the web content it presents to the user, so as to make the user's experience a better one.

It may be appreciated that stages 4A, 5A and 6A (the “A stages”), and stages 4B, 5B and 6B (the “B stages”) may be performed asynchronously. The A stages emanate from client compute 630, and the B stages emanate from server computer 600. The A stages and the B stages are somewhat parallel in nature. The point of dependency between the A stages and the B stages is that stage 5B cannot successfully retrieve the user information requested at stage 4B, until stage 5A has been completed. As such, the request for retrieval of the user's personal information at stage 5B may be delayed a short time, in order to allow time for a match to arrive from stage 5A.

It is noted that server computer 600 can cater to the asynchronous delay by automatically refreshing an initial page after a short period of time, thus turning a non-personalized view into a personalized one with the user interaction.

It may be appreciated that server computer 600 can make multiple requests to central computer 640, to get additional information about a visitor. The user information does not have to be retrieved all at once.

Reference is now made to FIG. 7, which is a simplified flowchart of a method for global personalization in accordance with a preferred embodiment of the present invention. FIG. 7 is divided into three columns. The left-most column includes operations performed by a server computer belonging to an e-commerce vendor, such as store.com server computer 600 (FIG. 6). The middle column includes operations performed by a user's client computer, such as client computer 630 (FIG. 6). The right-most column includes operations performed by a central computer, such as AboutMe.com server 640 (FIG. 6).

At step 700 a user navigates to the store.com web site. This corresponds to stage 1 in FIG. 6. At step 704 the store.com server composes an initial web page having an AboutMe.com banner link. At step 708 the store.com server generates a user ID that is preferably a universally unique identifier (UUID), and inserts it into the banner link. Preferably, steps 704 and 708, which correspond to stage 2 in FIG. 6, are performed by a personalization engine, such as personalization engine 620 (FIG. 6), within the store.com server computer. At step 712 the store.com server computer transmits the initial web page having the banner link to the client computer. This corresponds to stage 3 in FIG. 6.

At step 716 the client computer receives the initial web page having the banner link. In parsing the initial web page, a web browser within the client computer sends an HTTP request to the AboutMe.com computer to retrieve the resource pointed to by the banner link. If the client computer contains at AboutMe cookie (step 720), then at step 724 both the HTTP request and the AboutMe cookie are sent to the AboutMe.com computer. This corresponds to stage 4A in FIG. 6. Preferably, the AboutMe cookie includes a subscriber number for the user of the client computer.

At step 728 the AboutMe.com computer receives the HTTP request and the AboutMe cookie from the client computer. At step 732 the AboutMe.com computer checks if the cookie is valid. If so, then at step 736 the AboutMe.com computer sends back to the client computer a banner image indicating that the user has been recognized, such as green triangle 360 (FIG. 3C). This corresponds to stage 6A in FIG. 6. At step 740 the client computer receives the banner image. At step 744 the AboutMe.com computer associates the user ID within the HTTP request with the subscriber number in the AboutMe cookie, and stores the association in a user information database. This corresponds to stage 5A in FIG. 6.

If the client computer does not contain an AboutMe cookie (step 720), then at step 748 only the HTTP request is sent to the AboutMe.com computer. At step 752 the AboutMe.com computer receives the HTTP request, and at step 756 the AboutMe.com computer responds by sending back to the client computer an alternative image that links to an AboutMe.com login page, such as red triangle 370 (FIG. 3D). The alternative image indicates that the user has not been recognized and that he should establish or re-establish his identity. This also corresponds to stage 6A in FIG. 6. At step 760 the client computer receives the alternative image and at step 764 the web browser within the client computer follows the link for the image and navigates to the AboutMe.com login page. At step 768 the AboutMe.com computer authenticates the user. At step 772 the AboutMe.com computer checks if this is a new user. If so, at step 776 the user's personal information is obtained and entered into the user information database. Otherwise, if the AboutMe.com computer determines at step 772 that this is an existing user, then the user's subscriber number is obtained and used in step 744 to derive the relationship between the subscriber number and the user ID.

If the AboutMe.com computer determines at step 732 that the cookie is invalid, then it proceeds to step 756 where an image with a link to the AboutMe.com login page is sent back to the client computer.

At step 780 the store.com server sends a request to the AboutMe.com server for personal information about the user identified with the user ID. This corresponds to stage 4B in FIG. 4. Preferably, step 780 is performed by the personalization engine within the store.com server. At step 784 the AboutMe.com server receives the request from the store.com server, and at step 788 the AboutMe.com server queries the database to see if it has a match for a user identified by the user ID. After a match is found, at step 792 the AboutMe.com server retrieves the user's personal information, corresponding to stage 5B in FIG. 6, and sends it back to the store.com server, corresponding to stage 6B in FIG. 6. Finally, at step 796 the store.com server receives the requested user personal information.

It may be appreciated that an achievement of the present invention is the ability for the store.com server to request information at step 780 about a user who has navigated to the store.com web site, and be able to receive the desired information at step 796.

In reading the above description, persons skilled in the art will realize that there are many apparent variations that can be applied to the methods and systems described hereinabove. For example, referring to FIG. 6, database 650 may be included within central computer 640 or alternatively, it may be included within a different computer connected to computer 640 via a network.

It will be appreciated by persons skilled in the art that the present invention is not limited by what has been particularly shown and described hereinabove. Rather the present invention includes combinations and sub-combinations of the various features described hereinabove as well as modifications and extensions thereof which would occur to a person skilled in the art and which do not fall within the prior art.

What is claimed is:

1. A system for providing user information to a server computer, comprising:
a personalization engine within a server computer, comprising:
an ID generator generating a user ID, in response to a user initiating a session accessing the server computer;
a banner processor embedding a banner link within a web page to be transmitted from the server computer to the user, the banner link linking to a central computer and including the user ID; and
a request generator issuing a request to the central computer to provide user information corresponding to the user ID;
a database of user information indexed by user subscriber numbers;
a match processor within the central computer receiving the user ID and a user subscriber number, and associating the user ID with the user subscriber number; and
a database manager retrieving user information from said database for transmission to the server computer, in response to said request generator.

2. The system of claim 1 wherein said ID generator comprises a universal unique identifier (UUID) generator.

3. The system of claim 1 wherein the banner link is a link to a CGI program in the central computer.

4. The system of claim 1 wherein the user subscriber number is delivered to said match processor from the user's computer within an Internet browser cookie.

5. The system of claim 1 wherein the user information is formatted as an XML document.

6. The system of claim 1 further comprising a contact mode processor in the central computer for specifying by the user a mode of contact for contacting the user.

7. The system of claim 6 wherein said personalization engine further comprises a user contact processor for sending a message to the user, using the mode of contact specified by the user

8. The system of claim 6 wherein said contact mode processor enables a user to define a set of rules specifying different modes of contact for different types of information.

9. The system of claim 8 wherein said personalization engine further comprises a user contact processor for sending a message to the user, using the set of rules specified by the user.

10. A method for providing user information to a server computer, comprising:
generating a user ID, in response to a user initiating a session accessing a server computer;
embedding a banner link within a web page to be transmitted from the server computer to the user, the banner link linking to a central computer and including the user ID;
issuing a request to the central computer to provide user information corresponding to the user ID;
receiving the user ID and a user subscriber number;
associating the user ID with the user subscriber number;
retrieving user information from a database of user information indexed by user subscriber numbers, based on the user subscriber number associated with the user ID; and
transmitting the user information from the central computer to the server computer, in response to the request.

11. The method of claim 10 wherein said generating a user ID comprises generating a universal unique identifier (UUID).

12. The method of claim 10 wherein the banner link is a link to a CGI program in the central computer.

13. The method of claim 10 wherein said receiving receives the user subscriber number from the user's computer within an Internet browser cookie.

14. The method of claim 10 wherein the user information is formatted as an XML document.

15. The method of claim 10 further comprising specifying by the user a mode of contact for contacting the user.

16. The method of claim 15 further comprising sending a message to the user from the server computer, using the mode of contact specified by the user

17. The method of claim 15 wherein said specifying comprises defining a set of rules specifying different modes of contact for different types of information.

18. The method of claim 17 further comprising sending a message to the user from the server computer, using the set of rules specified by the user.

19. A system for providing user information to a server computer, comprising:
an ID generator generating a user ID, in response to a user initiating a session accessing a server computer;
a banner processor embedding a banner link within a web page to be transmitted from the server computer to the user, the banner link linking to a central computer and including the user ID; and
a request generator issuing a request to the central computer to provide user information corresponding to the user ID.

20. The system of claim 19 wherein the banner link is a link to a CGI program in the central computer.

21. The system of claim 19 further comprising a user contact processor for sending a message to the user via the central computer.

22. A method for providing user information to a server computer, comprising:
generating a user ID, in response to a user initiating a session accessing a server computer;
embedding a banner link within a web page to be transmitted from the server computer to the user, the banner link linking to a central computer and including the user ID; and
issuing a request to the central computer to provide user information corresponding to the user ID.

23. The method of claim 22 wherein the banner link is a link to a CGI program in the central computer.

24. The method of claim 22 further comprising sending a message to the user from the server computer via the central computer.

25. A system for providing user information to a server computer, comprising:
a database of user information indexed by user subscriber numbers;
a match processor within a central computer receiving a user ID and a user subscriber number from a server computer, and associating the user ID with the user subscriber number; and
a database manager retrieving user information about a user from said database in response to a request including the user ID.

26. The system of claim 25 wherein the user subscriber number is delivered to said match processor from a user's computer within an Internet browser cookie.

27. The system of claim 25 wherein the user information is formatted as an XML document.

28. The system of claim 25 further comprising a message manager for directing messages from the server computer to a user having a user subscriber number.

29. A method for providing user information to a server computer, comprising:
receiving a user ID and a user subscriber number from a server computer;
associating the user ID with the user subscriber number; and
transmitting user information about a user from a database of user information indexed by user subscriber numbers, in response to a request including the user ID.

30. The method of claim 29 wherein said receiving receives the user subscriber number from a user's computer within an Internet browser cookie.

31. The method of claim 29 wherein the user information is formatted as an XML document.

32. The method of claim 29 further comprising directing messages from the server computer to a user having a user subscriber number.
